(19) United States
(12) Patent Application Publication
(10) Pub. No.: US 2013/0179554 A1
(43) Pub. Date: Jul. 11, 2013

(54) METHOD, APPARATUS AND ELECTRONIC DEVICE FOR APPLICATION DISPLAY

(71) Applicants: BEIJING LENOVO SOFTWARE LTD, Beijing (CN); LENOVO (BEIJING) CO., LTD, Beijing (CN)

(72) Inventor: Qian Zhao, Beijing (CN)

(73) Assignees: LENOVO (BEIJING) CO., LTD, Beijing (CN); BEIJING LENOVO SOFTWARE LTD, Beijing (CN)

(21) Appl. No.: 13/729,293

(22) Filed: Dec. 28, 2012

(30) Foreign Application Priority Data
Jan. 6, 2012 (CN) 201210003993.9

(51) Int. Cl. H04L 29/08

(52) U.S. Cl. CPC H04L 67/32
USPC 709/223

(57) ABSTRACT

A method for application display, which is applicable for an electronic device, includes: obtaining a current state index of a parameter of the electronic device; detecting whether an application in the electronic device is capable of running under the state index of the parameter and obtaining a detection result; and if the detection result indicates that the application is not capable of running under the state index of the parameter, displaying the application in a preset way. Automatic prompt of unusable application is achieved and user experience is improved.

This application claims the priority of Chinese Patent Application 201210003993.9 entitled “METHOD, APPARATUS AND ELECTRONIC DEVICE FOR APPLICATION DISPLAY”, filed on Jan. 6, 2012 with State Intellectual Property Office of PRC. The aforementioned application is herein incorporated by reference in its entirety.

### FIELD OF THE INVENTION

The present invention relates to computer technology, and in particular, to method, apparatus and electronic device for application display.

### BACKGROUND OF THE INVENTION

Generally, an electronic device is installed with applications beforehand. Some of the applications, such as online games, are usable only when network connection is accessible. Applications depending on the network can not run when the network is unavailable.

There is such a situation at present: when the network is unavailable, the display of the applications depending on the network has no difference with that of other usable applications, and a user, who is not aware of the state of the network, would try out the applications before finding out that the network is unavailable, leading to a poor experience for the user.

### SUMMARY OF THE INVENTION

In view of the above, the present invention provides a method, an apparatus and an electronic device for application display, to solve the problem of the poor user experience caused by the existing display method in which the usable state and unusable state of applications are not distinguished.

A method for application display, which is applicable for an electronic device, includes:

obtaining a current state index of a parameter of the electronic device;

detecting whether an application in the electronic device is capable of running under the state index of the parameter, and obtaining a detection result; and

if the detection result indicates that the application in the electronic device is not capable of running under the state index of the parameter, displaying the application in a preset way.

Preferably, obtaining a current state index of a parameter of the electronic device includes:

acquiring a network connection state of the electronic device.

Preferably, detecting whether an application in the electronic device is capable of running under the state index includes:

in the case that the network connection state indicates that no network is available, detecting whether the application in the electronic device needs a network connection for running, and determining that the application is not capable of running at present if the application in the electronic device needs the network connection for running.

Preferably, obtaining a current state index of the parameter of the electronic device includes:

acquiring a current remaining memory capacity of the electronic device.

Preferably, detecting whether an application in the electronic device is capable of running under the state index includes:

detecting a memory capacity needed for the application in the electronic device, and determining that the application is not capable of running at present if the needed memory capacity is larger than the current remaining memory capacity.

Preferably, displaying in a preset way includes:

displaying with a transparent or grey icon.

An apparatus for application display, which is applicable for an electronic device, includes:

a state index obtaining module configured to obtain a current state index of a parameter of the electronic device;

an application detecting module configured to detect whether an application in the electronic device is capable of running under the state index of the parameter, and to obtain a detection result; and

a display module configured to display the application in a preset way if the detection result indicates that the application in the electronic device is not capable of running under the state index of the parameter.

Preferably, the state index obtaining module includes:

a network state obtaining module configured to obtain a network connection state of the electronic device.

Preferably, the state index obtaining module includes:

a memory state obtaining module configured to obtain a current remaining memory capacity of the electronic device.

An electronic device includes:

a processor configured to obtain a current state index of a parameter of the electronic device, to detect whether an application in the electronic device is capable of running under the state index of the parameter and to display the application which is not capable of running at present in a preset way.

According to the method, apparatus and electronic device for application display provided in the embodiments of the present invention, prompt to the user is implemented by comparing the index of the resource (such as network and memory) needed for each application with the current state index of the resource so as to detect whether the application is usable at present and display the application which is not capable of running at present in a different way from an application which is capable of running at present. Moreover, according to this method, the user may know the current state of a certain resource of the electronic device according to the display state of the application, and therefore the user experience is improved.

### BRIEF DESCRIPTION OF THE DRAWINGS

The drawings to be used in the description will be described briefly as follows, so that the technical solutions according to the embodiments of the present invention will become clearer. It is obvious that the drawings in the following description are only some embodiments of the present invention. For those skilled in the art, other drawings may be obtained according to these drawings without any creative work.

FIG. 1 is a flowchart of a method for application display disclosed in an embodiment of the present invention; and

FIG. 2 is a schematic structural diagram of an apparatus for application display disclosed in an embodiment of the present invention.

### DETAILED DESCRIPTION OF THE INVENTION

The present invention discloses a method, an apparatus and an electronic device for application display. By obtaining knowledge of current hardware resources or system resources such as network resources or memory resources in advance, an application which can not run with the current resources is displayed in a preset way as a prompt for the user.

The technical solution according to the embodiments of the present invention will be described clearly and completely as follows in conjunction with the drawings. It is obvious that the described embodiments are only some of the embodiments according to the present invention. Other embodiments obtained by those skilled in the art based on the embodiments in the present invention without any creative work fall into the scope of the present invention.

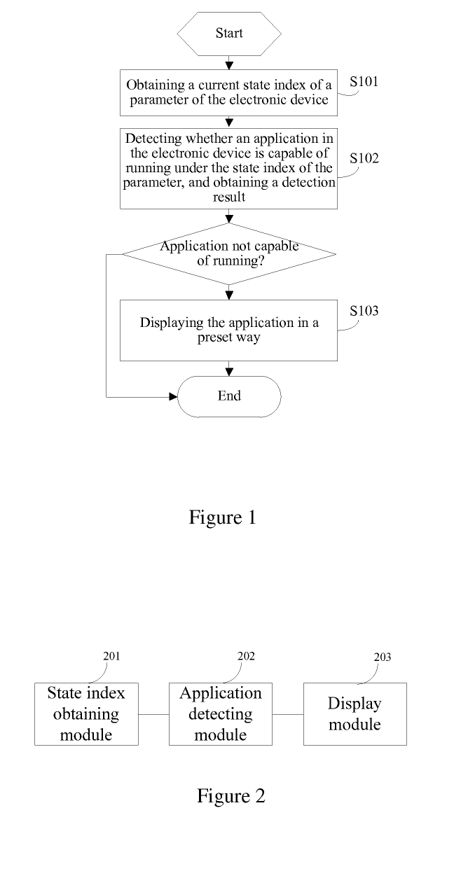

The present invention provides a method for application display, which is applicable for an electronic device installed with an application or applications such as Office or QQ. As shown in FIG. 1, the method includes the following steps:

S101: acquiring a current state index of a parameter of the electronic device;

The term parameter refers to a parameter of software or hardware in the electronic device, such as a network parameter, a memory parameter, a hard disk parameter a temperature parameter, and the like. The network parameter and the memory parameter may be regard as a parameter that indicates software or hardware resources in the electronic device, and the temperature parameter may be regard as a parameter that indicates the running state of the electronic device.

The parameter of which the current state index is to be obtained may be selected according a user pre-setting. In the present embodiment, the description is made in detail with two preferable parameters.

Further, obtaining a current state index of a parameter of the electronic device includes:

acquiring a network connection state of the electronic device, in which the current state includes whether a network to which the electronic device is connected is available or whether the electronic device is connected to the network. The method to obtain the knowledge of whether the network is available includes monitoring whether the data traffic in the network is larger than a preset value, and if the data traffic in the network is larger than the preset value, it is indicated that the network is available at present. The method to obtain the knowledge of whether the network is available may further include detecting whether the network can access a server, and if the network can access the server, it is indicated that the network is available at present.

Alternatively, obtaining a current state index of a parameter of the electronic device includes:

acquiring a current remaining memory capacity of the electronic device, in which the remaining memory capacity refers to the overall memory capacity of the electronic device subtracted by the memory capacity occupied by the application(s) running at present.

S102: detecting whether the application(s) in the electronic device is capable of running under the state index of the parameter, and obtaining a detection result;

As described previously, in the case that the obtained parameter is the current network connection state of the electronic device and the current network connection state indicates that no network is available, it is detected whether the network connection is required for the running of the application(s) in the electronic equipment. If the network connection is required for the running of the application(s), a detection result, which indicates the application as not capable of running at present, is obtained. For example, QQ is detected to be an application that can run only when being connected to the network, and it is determined that QQ can not run in the case that no network is available at present. It should be emphasized that this step may be omitted when the obtained current network connection state indicates that the network is available.

In the case that the obtained parameter is the current remaining memory capacity of the electronic device, a memory capacity needed for each application in the electronic device is detected. When the needed memory capacity is larger than the current remaining memory capacity, it is indicated that the system may crash when the application runs. Therefore, the detection result, which indicates the application as not capable of running at present, is obtained.

S103: if the detection result indicates that the application(s) in the electronic device can not run under the state index of the parameter, displaying the application(s) in a preset way.

Displaying in a preset way includes displaying with a gray or transparent icon. However, the embodiment is not limited thereto, as long as the application(s) which can not run can be displayed as being distinguished from an application which is capable of running.

For example, if it is detected that QQ can not run, the icon of QQ can be displayed to be gray, semi-transparent or transparent, so that the user is prompted that this application can not run at present.

In the method for application display according to the embodiment, an application which can not run under a current state index of a parameter is displayed in a different way from an application which can run under the current state index of the parameter, so that it is very clear for a user whether the application is capable of running, which changes the situation that the user has to try out an application to know whether the application is capable of running in the case that the user does not know the software or hardware parameter. Furthermore, the user can also know the current state index of the software or hardware parameter through the display of the application, resulting in an improvement in the user experience.

The present invention further discloses an apparatus for application display, which is applicable for an electronic device installed with an application. As shown in FIG. 2, the apparatus includes:

a state index obtaining module 201 configured to obtain a current state index of a parameter of the electronic device;

particularly, this module may be a network state obtaining module configured to obtain the network connection state of the electronic device, or this module may also be a memory state obtaining module configured to obtain a current remaining memory capacity of the electronic device, or this module may include both the network state obtaining module and the memory state obtaining module so as to be able to obtain both a network state index and a memory state index;

an application detecting module 202 configured to detect whether an application in the electronic device is capable of running under the state index of the parameter, and to obtain a detection result;

it should be noted that the application detecting module and the state index obtaining module are set to be corresponding to each other, so that when the state index obtaining module is to obtain a network connection state, the application detecting module is to detect whether the application is capable of running in the current network connection state; and when the state index obtaining module is to obtain a current remaining memory capacity, the application detecting module is to detect whether the memory capacity required for running the application is larger than the remaining memory capacity;

a display module 203 configured to, if the detection result indicates that the application in the electronic device can not run under the state index of the parameter, display the application, which can not run at present, in a preset way.

The apparatus for application display according to the embodiment may display in a preset way the application which can not run with the current resource, so as to prompt the user which application is unusable and thereby improve the user experience.

The present invention further discloses an electronic device which is installed with an application or applications. The electronic device includes:

a processor configured to obtain a current state index of a parameter of the electronic device, to detect whether an application in the electronic device is capable of running under the state index of the parameter and to display the application which can not run at present in a preset way.

The processor may be set separately to perform the above-mentioned function, or be combined with a processor which performs other control functions of the electronic device.

When the electronic device is used by a user, the processor may detect according to a selection of the user or automatically whether an installed application is capable of running in the current network state or memory state, and display the application which can not run with a gray or transparent icon. The user may determine the availability of the application according to the icon of the application, so that the user experience is improved greatly.

The embodiments of the present invention are described herein in a progressive manner, each of which emphasizes the differences from others, and the same or similar parts among the embodiments can be referred to each other.

With the above descriptions of the disclosed embodiments, the skilled in the art may practice or use the present invention. Various modifications to the embodiments are apparent for the skilled in the art. The general principle suggested herein can be implemented in other embodiments without departing from the spirit or scope of the invention. Therefore, the present invention should not be limited to the embodiments disclosed herein, but has the widest scope that is conformity with the principle and the novel features disclosed herein.

1. A method for application display, which is applicable for an electronic device, comprising:
obtaining a current state index of a parameter of the electronic device;
detecting whether an application in the electronic device is capable of running under the state index of the parameter, and obtaining a detection result; and
if the detection result indicates that the application in the electronic device is not capable of running under the state index of the parameter, displaying the application in a preset way.

2. The method according to claim 1, wherein obtaining the current state index of the parameter of the electronic device comprises:
obtaining a network connection state of the electronic device.

3. The method according to claim 2, wherein detecting whether the application in the electronic device is capable of running under the state index comprises:
in the case that the network connection state indicates that no network is available, detecting whether the application in the electronic device needs a network connection for running, and determining that the application is not capable of running at present if the application needs the network connection for running.

4. The method according to claim 1, wherein obtaining the current state index of the parameter of the electronic device comprises:
obtaining a current remaining memory capacity of the electronic device.

5. The method according to claim 4, wherein detecting whether the application in the electronic device is capable of running under the state index comprises:
detecting a memory capacity needed for the application in the electronic device, and determining that the application is not capable of running at present if the needed memory capacity is larger than the current remaining memory capacity.

6. The method according to claim 1, wherein displaying in a preset way comprises:
displaying with a transparent or gray icon.

7. An apparatus for application display, which is applicable for an electronic device, comprising:
a state index obtaining module configured to obtain a current state index of a parameter of the electronic device;
an application detecting module configured to detect whether an application in the electronic device is capable of running under the state index of the parameter, and to obtain a detection result; and
a display module configured to display the application in a preset way if the detection result indicates that the application in the electronic device is not capable of running under the state index of the parameter.

8. The apparatus according to claim 7, wherein the state index obtaining module comprises:
a network state obtaining module configured to obtain a network connection state of the electronic device.

9. The apparatus according to claim 7, wherein the state index obtaining module comprises:
a memory state obtaining module configured to obtain a current remaining memory capacity of the electronic device.

10. An electronic device comprising:
a processor configured to obtain a current state index of a parameter of the electronic device, to detect whether an application in the electronic device is capable of running under the state index of the parameter and to display the application which is not capable of running at present in a preset way.
